(19) United States
(12) Patent Application Publication
(10) Pub. No.: US 2013/0046567 A1
(43) Pub. Date: Feb. 21, 2013

(54) SYSTEMS AND METHODS FOR USE IN EVALUATING WORK ESTIMATION

(71) Applicant: Michael Todd Swanson, Melbourne, FL (US)

(72) Inventor: Michael Todd Swanson, Melbourne, FL (US)

(21) Appl. No.: 13/210,971

(22) Filed: Aug. 16, 2011

(51) Int. Cl. G06Q 10/00

(52) U.S. Cl. 705/7.11

(57) ABSTRACT

A method for use in evaluating work estimation is provided. The method includes selecting a plurality of work units associated with a time and a level of effort. Each work unit includes one or more tasks. A total estimated duration associated with each work unit is determined based on estimated durations associated with the tasks included in the work unit. An estimation trend corresponding to the level of effort is determined. The estimation trend represents a change over time in the total estimated durations associated with the level of effort. The estimation trend is provided for presentation to a user.

### BACKGROUND OF THE INVENTION

The subject matter disclosed herein relates generally to work planning and, more specifically, to systems and methods for use in evaluating trends in work estimation.

Work, such as a software development project, may be organized into work units, each of which includes one or more tasks. At least some known project management systems allow a level of effort to be associated with a work unit and also allow estimated durations of work to be associated with the tasks in the work unit. Further, some known project management systems calculate project team productivity for a period of time by determining the total level of effort associated with work units completed during the period.

Due to lower-than-expected productivity or variance between estimated and actual work durations, a project team may over time assign higher levels of effort to work units associated with the same total estimated work duration. Accordingly, productivity may appear to increase over time, even as the work performed by the project team remains constant or decreases. Such a misrepresentative productivity measure may produce an unrealistic expectation of the volume of work the project team can accommodate and/or negatively affect staffing decisions.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a system for use in evaluating work estimation. The system includes a memory device that is configured to store a plurality of work units. Each work unit is associated with a time and a level of effort, and each work unit includes one or more tasks, each of which is associated with an estimated duration. The system also includes a processor that is coupled in communication with the memory device and programmed to select a portion of the work units that are associated with a first level of effort, and to determine a total estimated duration associated with each work unit of the portion of work units based on the estimated durations associated with the tasks included in the work unit. The processor is also programmed to determine an estimation trend corresponding to the first level of effort. The estimation trend represents a change over time in the total estimated durations associated with the first level of effort. The system further includes a presentation device that is coupled in communication with the processor and configured to present the estimation trend.

In another aspect, a method for use in evaluating work estimation is provided. The method includes selecting, by a computing device, a plurality of work units associated with a time and a level of effort. Each work unit includes one or more tasks. A total estimated duration associated with each work unit is determined by the computing device based on estimated durations associated with the tasks included in the work unit. An estimation trend corresponding to the level of effort is determined by the computing device. The estimation trend represents a change over time in the total estimated durations associated with the level of effort. The estimation trend is provided for presentation to a user by the computing device.

In yet another aspect, one or more non-transitory computer-readable storage media having computer-executable instructions embodied thereon are provided. When executed by at least one processor, the computer-executable instructions cause the processor to select a plurality of work units that are associated with a same level of effort, wherein each work unit is further associated with a time, to determine a total estimated duration associated with each work unit, wherein the total estimated duration is based on estimated durations associated with tasks included in the work unit, to determine an estimation trend corresponding to the level of effort, wherein the estimation trend represents a change over time in the total estimated durations associated with the level of effort, and to provide the estimation trend for presentation to a user.

### BRIEF DESCRIPTION OF THE DRAWINGS

The embodiments described herein may be better understood by referring to the following description in conjunction with the accompanying drawings.

FIG. 1 is a block diagram of an exemplary computing device;

FIG. 2 is block diagram of an exemplary work management system that includes a project management server, a software development device, and a team management device;

FIG. 3 is a flowchart of an exemplary method for use in evaluating work estimation;

FIG. 4 is an exemplary user interface for presenting estimation information corresponding to a level of effort; and

FIG. 5 is an exemplary user interface for presenting estimation information corresponding to a plurality of levels of effort.

### DETAILED DESCRIPTION OF THE INVENTION

The embodiments described herein enable evaluation of work estimation. Specifically, in some embodiments, an estimation trend is determined based on a level of effort and a plurality of estimated durations associated with each of a plurality of work units.

As used herein, the term “work unit” refers to the effort (e.g., human labor) required to satisfy one or more project requirements, such as technical requirements and/or functional requirements. A work unit is associated with a level of effort that indicates an approximate difficulty or relative amount of work represented by the work unit. For example, levels of effort may include predetermined difficulty descriptions (e.g., easy, normal, and/or difficult) and/or numerical rankings (e.g., 1, 2, 3, 5, 8, and/or 13), the values of which may be referred to as “points.” In the context of software development, work units may be referred to as “user stories” or simply “stories.”

For each work unit, one or more tasks is defined, with each task representing a portion of work to be performed in completing the work unit. An estimated duration (e.g., expressed in hours or person-hours) is associated with each task. When a task is completed, an actual duration, representing the duration worked to complete the task, may be associated with the task. Although embodiments are described below with reference to software development, such embodiments are applicable to any work that can be divided into work units and tasks.

An exemplary technical effect of the methods, systems, and apparatus described herein includes at least one of (a) identifying, by a computing device, a plurality of work units associated with a time and a level of effort, wherein each work unit includes one or more tasks; (b) determining, by the computing device, a total estimated duration associated with each work unit based on an estimated duration associated with the tasks included in the work unit; (c) determining, by the computing device, an estimation trend corresponding to the level of effort, wherein the estimation trend represents a change over time in the total estimated durations associated with the level of effort; (d) providing, by the computing device, the estimation trend for presentation to a user; and (e) presenting a warning indicator when the estimation trend represents a change over time that violates a predetermined change threshold value.

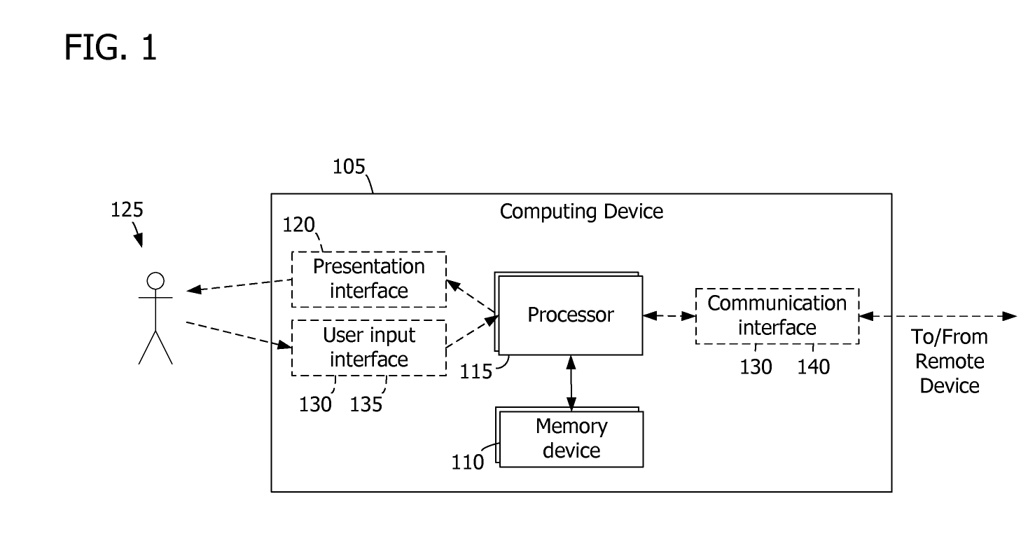

FIG. 1 is a block diagram of an exemplary computing device 105. Computing device 105 includes a memory device 110 and a processor 115 coupled to memory device 110 for executing instructions. In some embodiments, executable instructions are stored in memory device 110. Computing device 105 is configurable to perform one or more operations described herein by programming processor 115. For example, processor 115 may be programmed by encoding an operation as one or more executable instructions and providing the executable instructions in memory device 110. Processor 115 may include one or more processing units (e.g., in a multi-core configuration).

Memory device 110 is one or more devices that enables information such as executable instructions and/or other data to be stored and retrieved. Memory device 110 may include one or more computer readable media, such as, without limitation, dynamic random access memory (DRAM), static random access memory (SRAM), a solid state disk, and/or a hard disk. Memory device 110 may be configured to store, without limitation, project requirements, work units, tasks, levels of effort, estimated durations, actual durations, threshold values, and/or any other type of data.

In some embodiments, computing device 105 includes a presentation interface 120 that is coupled to processor 115. Presentation interface 120 presents information, such as a user interface, application source code, input events, and/or validation results to a user 125. For example, presentation interface 120 may include a display adapter (not shown in FIG. 1) that may be coupled to a display device, such as a cathode ray tube (CRT), a liquid crystal display (LCD), an organic LED (OLED) display, and/or an “electronic ink” display. In some embodiments, presentation interface 120 includes one or more display devices. In addition to, or in the alternative, presentation interface 120 may include an audio output device (e.g., an audio adapter and/or a speaker) and/or a printer.

In some embodiments, computing device 105 includes an input interface 130, such as a user input interface 135 or a communication interface 140. Input interface 130 may be configured to receive any information suitable for use with the methods described herein.

In the exemplary embodiment, user input interface 135 is coupled to processor 115 and receives input from user 125. User input interface 135 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone). A single component, such as a touch screen, may function as both a display device of presentation interface 120 and user input interface 135.

Communication interface 140 is coupled to processor 115 and is configured to be coupled in communication with one or more remote devices, such as another computing device 105. For example, communication interface 140 may include, without limitation, a wired network adapter, a wireless network adapter, and/or a mobile telecommunications adapter. Communication interface 140 may also transmit data to one or more remote devices. For example, a communication interface 140 of one computing device 105 may transmit an indication of one or more source code portions of interest and/or one or more execution events to the communication interface 140 of another computing device 105.

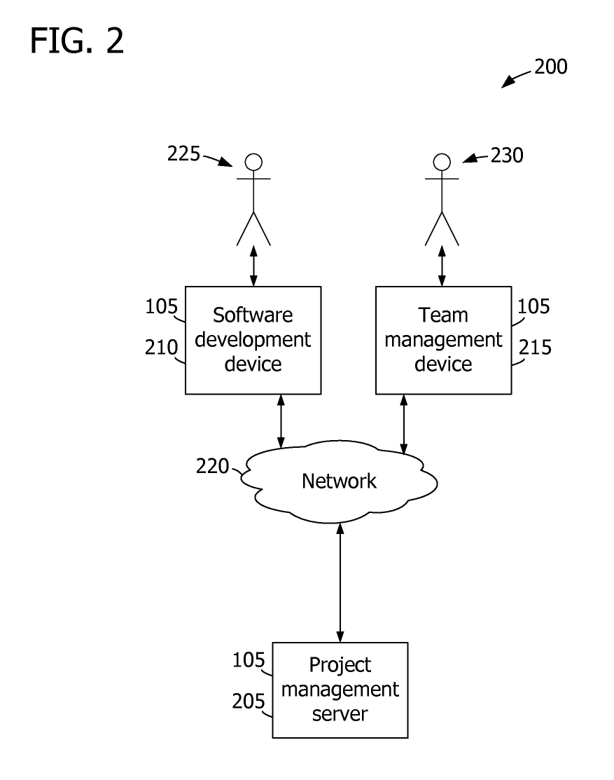

FIG. 2 is block diagram of an exemplary system 200 including a project management server 205, a software development device 210, and a team management device 215 coupled in communication via a network 220. Network 220 may include, without limitation, the Internet, a local area network (LAN), a wide area network (WAN), a wireless LAN (WLAN), a mesh network, and/or a virtual private network (VPN). While certain operations are described below with respect to particular computing devices 105, it is contemplated that any computing device 105 may perform one or more of the described operations. For example, software development device 210 may perform all of the operations below.

Project management server 205, software development device 210, and team management device 215 are computing devices 105 (shown in FIG. 1). In the exemplary embodiment, each computing device 105 is coupled to network 220 via communication interface 140 (shown in FIG. 1). In an alternative embodiment, project management server 205 is integrated with software development device 210 and/or with team management device 215.

Software development device 210 interacts with a software developer 225 (e.g., via user input interface 135 and/or presentation interface 120). For example, software development device 210 may be configured to receive project data, such as work units, levels of effort, tasks, estimated durations, and/or actual durations, from software developer 225. Software development device 210 transmits the project data to project management server 205 via network 220. Project management server 205 receives and stores the project data (e.g., in memory device 110).

Team management device 215 interacts with a team manager 230 (e.g., via user input interface 135 and/or presentation interface 120). For example, team management device 215 may receive project data from, and/or present project data to, team manager 230. For example, team management device 215 may present estimation trends to team manager 230.

In some embodiments, team management device 215 is remote to project management server 205. For example, team management device 215 may be located at a facility that is geographically removed from project management server 205 and/or software development device 210.

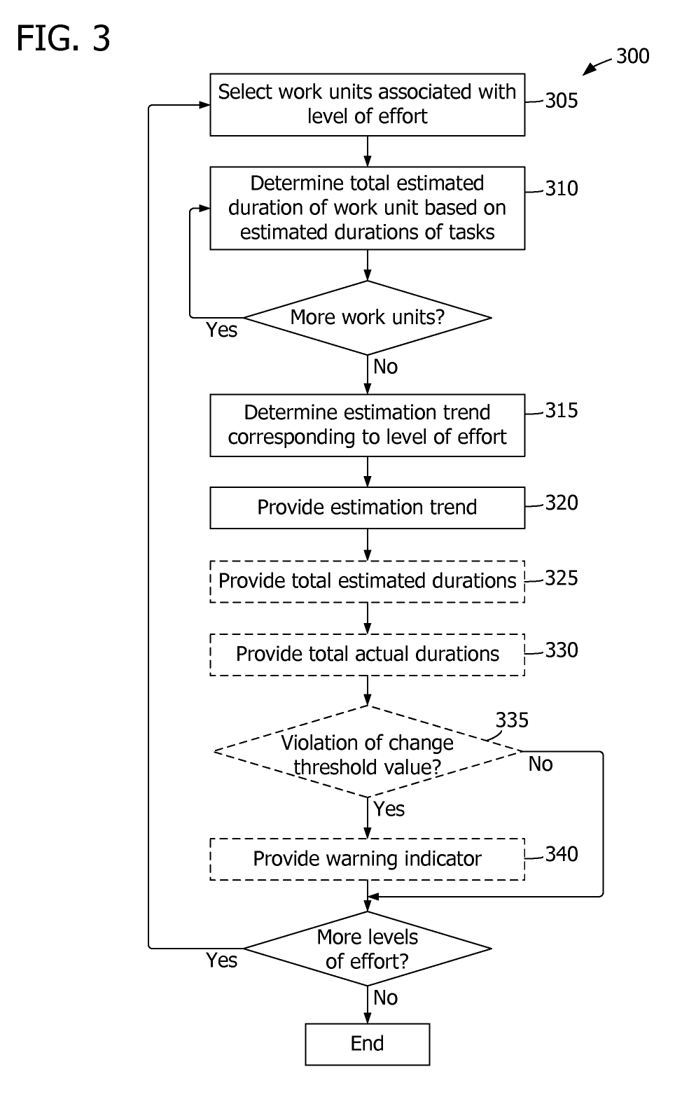

FIG. 3 is a flowchart of an exemplary method 300 for use in evaluating work estimation. Portions of method 300 may be performed, for example, using any one of or any combination of computing devices 105 in system 200 (shown in FIG. 2).

Referring to FIGS. 2 and 3, in exemplary embodiments, a plurality of work units is stored by project management server 205 (e.g., by memory device 110, shown in FIG. 1). Each work unit is associated with a time (e.g., a date and/or a time of day) and a level of effort, such as a quantity of “points” that indicates the difficulty of a work unit relative to other work units. The time may represent a start time and/or a due time. In some embodiments, each work unit is assigned to a work period (e.g., a week, a bi-week, or a month), which may be referred to as an “iteration,” and the time associated with the work unit is equal to the start time and/or the end time of the work period.

Each work unit includes one or more tasks, and each task is associated with an estimated duration that represents a quantity of time expected for a person to perform the task. For example, expected durations may be expressed in hours or person-hours. When a task is completed, an actual duration may be associated with the task. The actual duration represents the quantity of time spent to complete the task. Actual durations may be expressed in the same units used to express expected durations (e.g., hours and/or person-hours).

In exemplary embodiments, project management server 205 selects 305 work units that are associated with a particular level of effort. For example, the level of effort may be selected by a user. In addition, or alternatively, project management server 205 may iterate or “loop” over a plurality of levels of difficulty, as described in more detail below.

Project management server 205 determines 310 a total estimated duration associated with each work unit based on the estimated durations associated with the tasks included in the work unit. For example, the total estimated duration may be equal to the sum of the individual estimated durations.

Project management server 205 determines 315 an estimation trend corresponding to the level of effort. The estimation trend represents a change over time in the total estimated durations associated with the level of effort. In exemplary embodiments, the estimation trend is determined 315 at least in part by ordering the work units in ascending order by the associated times, fitting a trend line to the total estimated durations, and calculating the slope of the trend line. Accordingly, the estimation trend may include a numerical value equal to the slope of the trend line.

A slope of zero indicates no change in the total estimated duration associated with the level of effort. A positive slope indicates that, over time, a higher total estimated duration has been associated with the level of effort. A negative slope indicates that, over time, a lower total estimated duration has been associated with the level of effort.

In some embodiments, project management server 205 identifies any work units that are associated with the same time (e.g., the same work period) and collapses these work units into a single work unit with a total estimated duration equal to the average of the total estimated durations associated with the individual work units. Such embodiments facilitate calculating the estimation trend using a consistent time scale between work units.

Project management server 205 provides 320 the estimation trend for presentation to a user. For example, project management server 205 may provide 320 the estimation trend by presenting the estimation trend (e.g., using presentation interface 120, shown in FIG. 1) and/or by transmitting the estimation trend to team management device 215 and/or software development device 210 (e.g., using communication interface 140, shown in FIG. 1).

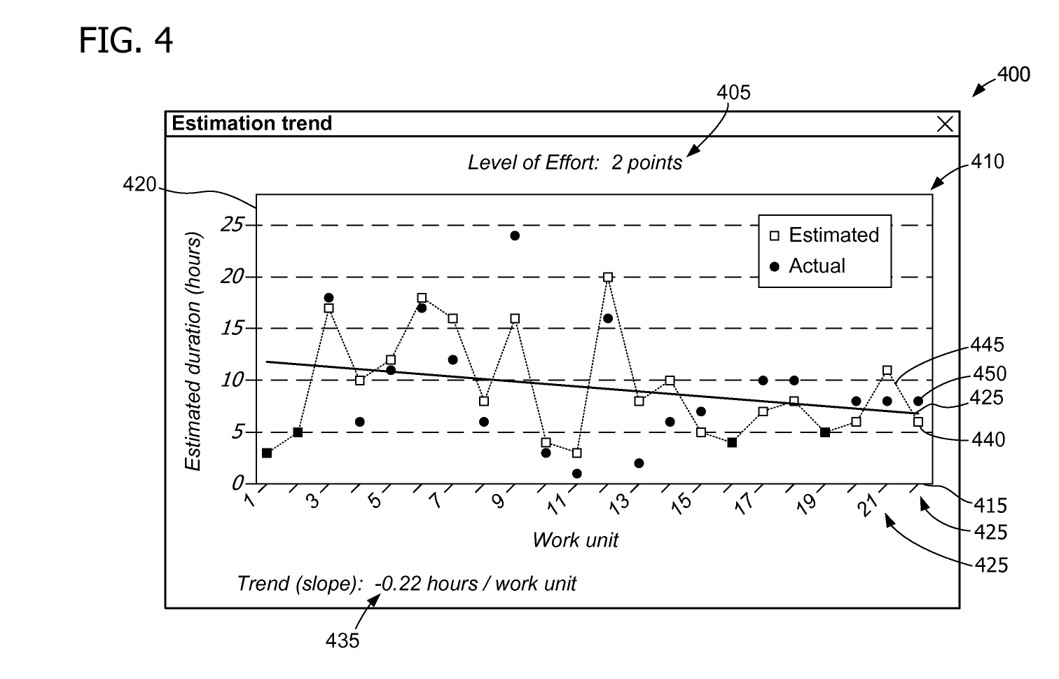

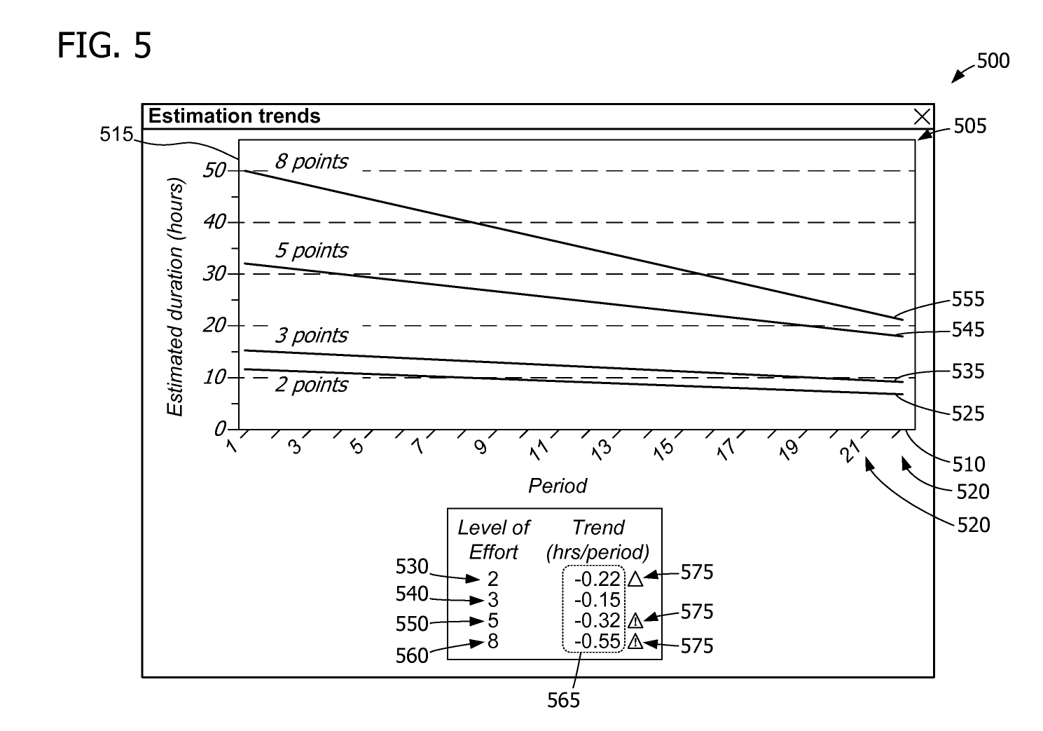

Further, in some embodiments, providing 320 the estimation trend may include providing 320 a numerical value (e.g., the slope of the trend line) and/or providing 320 a graph including the trend line, as described in more detail below with reference to FIGS. 4 and 5.

FIG. 4 is an exemplary user interface 400 for presenting estimation information corresponding to a level of effort 405. Referring to FIGS. 2, 3, and 4, in exemplary embodiments, user interface 400 is provided 320 by team management device 215, software development device 210, and/or project management server 205.

User interface 400 includes a graph 410 depicting the estimation trend determined 315 by project management server 205. Graph 410 includes an x-axis 415 and a y-axis 420. X-axis 415 represents work units 425 associated with level of effort 405. Y-axis 420 represents the total estimated duration associated with each work unit 425. Graph 410 further includes a trend line 430 that represents the estimation trend. User interface 400 may also include a numerical estimation trend value 435 that is equal to the slope of trend line 430.

In some embodiments, project management server 205 provides 325 total estimated durations 440 associated with work units 425. In the exemplary embodiment, graph 410 includes the total estimated duration 440 associated with each work unit 425 and a total estimated duration line 445 connecting total estimated durations 440.

In addition, or alternative to, project management server 205 may provide 330 actual total durations 450 associated with work units 425. In the exemplary embodiment, graph 410 includes an actual total duration 450 associated with each work unit 425. The actual total duration 450 associated with a work unit 425 may be determined, for example, by calculating the sum of the actual durations associated with the tasks included in the work unit 425. Providing 325 total estimation durations 440 and providing 330 total actual durations 450 facilitates comparing estimates to actual performance.

In some embodiments, project management server 205 determines 315 estimation trends corresponding to a plurality of levels of effort. For example, for each level of effort, project management server 205 may select 305 work units associated with the level of effort, determine 310 the total estimated duration of each work unit, determine 315 an estimation trend based on the total estimated durations, and provide 320 the estimation trend. Each estimation trend may be presented in a separate graph, such as graph 400, for example, or in a single graph, as described below with reference to FIG. 5.

FIG. 5 is an exemplary user interface 500 for presenting estimation information corresponding to a plurality of levels of effort. Referring to FIGS. 2, 3, and 5, in exemplary embodiments, user interface 500 is provided 320 by team management device 215, software development device 210, and/or project management server 205.

In the exemplary embodiment, user interface 500 includes a graph 505 depicting estimation trends corresponding to four levels of effort. Graph 505 includes an x-axis 510 and a y-axis 515. X-axis 510 represents work periods 520, such as weeks, bi-weeks, or months. Y-axis 515 represents the total estimated durations (e.g., average total estimated durations) associated with work units in each work period 520.

Graph 505 further includes a first trend line 525 that represents the estimation trend corresponding to a first level of effort 530, a second trend line 535 that represents the estimation trend corresponding to a second level of effort 540, a third trend line 545 that represents the estimation trend corresponding to a third level of effort 550, and a fourth trend line 555 that represents the estimation trend corresponding to a fourth level of effort 560.

User interface 500 also includes numerical estimation trend values 565 corresponding to first level of effort 530, second level of effort 540, third level of effort 550, and fourth level of effort 560. In the exemplary embodiment, numerical estimation trend values 565 are equal to the slopes of respective trend lines 525, 535, 545, 555.

Some embodiments facilitate providing a warning when an estimation trend indicates that the total estimated duration associated with a particular level of effort has changed (e.g., increased or decreased) at an unacceptable rate. In the exemplary embodiment, one or more predetermined change threshold values are stored by project management server 205 (e.g., by memory device 110, shown in FIG. 1). For example, project management server 205 may store a moderate threshold value and a critical threshold value.

A change threshold value may be positive or negative. A positive change threshold value is considered violated when an estimation trend represents a change in total estimated durations over time that is greater than the positive change threshold value. A negative change threshold value is considered violated when an estimation trend represents a change in total estimated durations over time that is less than the negative change threshold value.

In such embodiments, project management device 205 determines 335 whether the estimation trend previously determined 315 represents a change over time that violates any predetermined change threshold values. If so, project management device 205 provides 340 a warning indicator. In the exemplary embodiment, a moderate threshold value of −0.2 and a critical threshold value of −0.3 are defined. User interface 500 displays a critical warning indicator 570 adjacent to numerical estimation trend values 565 corresponding to third level of effort 550 and fourth level of effort 560, respectively. Critical warning indicators 570 signify that the corresponding numerical estimation trend values 565 violate the critical threshold value. User interface 500 displays a moderate warning indicator 575 adjacent to a numerical estimation trend value 565 corresponding to first level of effort 530. Moderate warning indicator 575 signifies that the corresponding numerical estimation trend value 565 violates the moderate warning threshold value.

Embodiments provided herein enable evaluating work estimation trends. Specifically, an estimation trend is determined for one or more levels of effort. The estimation trend represents a change over time in the total estimated duration associated with the level of effort. Accordingly, a user may easily determine whether the level of effort associated with a given amount of work has changed, and by how much, over time. Estimation trends may be presented graphically (e.g., as trend lines), enabling visual evaluation, and a warning indicator may be provided when the total estimated duration associated with a particular level of effort has changed at an unacceptable rate.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other apparatus and methods.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention may be practiced with modification within the spirit and scope of the claims.

What is claimed is:

1. A system for use in evaluating work estimation, said system comprising:
a memory device configured to store a plurality of work units, wherein each work unit is associated with a time and a level of effort, and each work unit includes one or more tasks associated with an estimated duration;
a processor coupled in communication with said memory device and programmed to:
select a portion of the work units that are associated with a first level of effort;
determine a total estimated duration associated with each work unit of the portion of work units based on the estimated durations associated with the tasks included in the work unit; and
determine an estimation trend corresponding to the first level of effort, wherein the estimation trend represents a change over time in the total estimated durations associated with the first level of effort; and
a presentation device coupled in communication with said processor and configured to present the estimation trend.

2. A system according to claim 1, wherein the estimation trend is a first estimation trend corresponding to a first portion of work units, said processor is further programmed to:
select a second portion of the work units that are associated with a second level of effort;
determine a total estimated duration associated with each work unit of the second portion of work units based on the estimated durations associated with the tasks included in the work unit; and
determine a second estimation trend corresponding to the second level of effort, wherein the second estimation trend represents a change over time in the total estimated durations associated with the second level of effort.

3. A system according to claim 1, wherein said processor is further programmed to generate a graphical representation of the estimation trend, said presentation device is configured to present the graphical representation of the estimation trend.

4. A system according to claim 3, wherein said processor is programmed to generate the graphical representation of the estimation trend at least in part by generating a graph that includes a trend line based on the estimation trend.

5. A system according to claim 1, wherein said presentation device is further configured to present the total estimated durations associated with the first level of effort.

6. A system according to claim 1, wherein said presentation device is further configured to present total actual durations corresponding to the total estimated durations.

7. A system according to claim 1, where said memory device is further configured to store a predetermined change threshold value, said presentation device is further configured to present a warning indicator when the estimation trend represents a change over time that violates the change threshold value.

8. A method for use in evaluating work estimation, said method comprising:
selecting, by a computing device, a plurality of work units associated with a time and a level of effort, wherein each work unit includes one or more tasks;
determining, by the computing device, a total estimated duration associated with each work unit based on estimated durations associated with the tasks included in the work unit;
determining, by the computing device, an estimation trend corresponding to the level of effort, wherein the estimation trend represents a change over time in the total estimated durations associated with the level of effort; and
providing, by the computing device, the estimation trend for presentation to a user.

9. A method according to claim 8, wherein the estimation trend is a first estimation trend corresponding to a first level of effort, said method further comprising:
determining, by the computing device, a total estimated duration associated with each work unit of a plurality of work units that are associated with a second level of effort;
determining, by the computing device, a second estimation trend corresponding to the second level of effort, wherein the second estimation trend represents a change over time in the total estimated durations associated with the second level of effort; and
providing, by the computing device, the second estimation trend for presentation to the user.

10. A method according to claim 9, wherein providing the first estimation trend and the second estimation trend comprises:
generating a first graph depicting the first estimation trend; and
generating a second graph depicting the second estimation trend.

11. A method according to claim 9, wherein providing the first estimation trend and the second estimation trend comprises generating a graph depicting the first estimation trend and the second estimation trend.

12. A method according to claim 8, further comprising providing the total estimated durations for presentation to the user.

13. A method according to claim 12, further comprising providing total actual durations corresponding to the total estimated durations for presentation to the user.

14. A method according to claim 8, further comprising presenting a warning indicator when the estimation trend represents a change over time that violates a predetermined change threshold value.

15. A method according to claim 8, wherein providing the estimation trend for presentation comprises providing a graph including a trend line that is based on the total estimated durations.

16. One or more non-transitory computer-readable storage media having computer-executable instructions embodied thereon, wherein when executed by at least one processor, the computer-executable instructions cause the processor to:
select a plurality of work units that are associated with a same level of effort, wherein each work unit is further associated with a time;
determine a total estimated duration associated with each work unit, wherein the total estimated duration is based on estimated durations associated with tasks included in the work unit;
determine an estimation trend corresponding to the level of effort, wherein the estimation trend represents a change over time in the total estimated durations associated with the level of effort; and
provide the estimation trend for presentation to a user.

17. One or more storage media according to claim 16, wherein the estimation trend is a first estimation trend corresponding to a first level of effort, said computer-executable instructions further cause the processor to:
select a plurality of work units that are associated with a second level of effort, wherein each work unit is further associated with a time;
determine a total estimated duration associated with each work unit that is associated with the second level of effort;
determine a second estimation trend corresponding to the second level of effort, wherein the second estimation trend represents a change over time in the total estimated durations associated with the second level of effort; and
provide the second estimation trend for presentation to a user.

18. One or more storage media according to claim 16, wherein said computer-executable instructions further cause the processor to present a warning indicator when the estimation trend represents a change over time that violates a predetermined change threshold value.

19. One or more storage media according to claim 16, wherein said computer-executable instructions cause the processor to present the estimation trend at least in part by presenting a graph including a trend line based on the estimation trend.

20. One or more storage media according to claim 16, wherein said computer-executable instructions further cause the processor to present each total estimated duration based on the time associated with the associated work unit.
